(19) United States
(12) Patent Application Publication
(10) Pub. No.: US 2020/0368842 A1
(43) Pub. Date: Nov. 26, 2020

(54) ONE-SIDE SUBMERGED ARC WELDING METHOD AND ONE-SIDE SUBMERGED ARC WELDING DEVICE

(71) Applicant: Kabushiki Kaisha Kobe Seiko Sho (Kobe Steel, Ltd.), Kobe-shi (JP)

(72) Inventors: Hiroyoshi YOKOTA, Kanagawa (JP); Takanobu SUWA, Kanagawa (JP); Masaharu KOMURA, Kanagawa (JP); Shigeru KIHATA, Kanagawa (JP); Daisuke SUGIYAMA, Kanagawa (JP)

(73) Assignee: Kabushiki Kaisha Kobe Seiko Sho (Kobe Steel, Ltd.), Kobe-shi (JP)

(21) Appl. No.: 16/966,356

(22) PCT Filed: Jan. 25, 2019
(86) PCT No.: PCT/JP2019/002566

§ 371 Date: Jul. 30, 2020

(30) Foreign Application Priority Data
Jan. 31, 2018 (JP) 2018-015837

(51) Int. Cl. B23K 9/18; B23K 9/12; B23K 9/095; B23K 9/02; B23K 31/00

(52) U.S. Cl. CPC B23K 9/188; B23K 9/12; B23K 2103/04; B23K 9/02; B23K 31/003; B23K 9/095

(57) ABSTRACT

A one-side submerged arc welding method, includes joining two steel plates butted against each other by submerged arc welding from one side using a plurality of electrode. During the submerged arc welding, at least one of electrode distances between adjacent electrodes in an end part region of the steel plates is reduced to be smaller than the at least one of electrode distances in a region in front of the end part region. In reducing the at least one of electrode distances, an increasing section of change rate from when a change of the at least one of electrode distances starts to when the change rate of the at least one of electrode distances reaches its maximum has a time of 2 seconds or more.

### TECHNICAL FIELD

The present invention relates to a one-side submerged arc welding method and a one-side submerged arc welding device.

### BACKGROUND ART

One-side submerged arc welding is a highly efficient welding method applied to a wide range of fields, mainly shipbuilding as plate joint welding. On the other hand, in the one-side submerged arc welding, cracks may occur at an end part of a weld joint, and various proposals have been made as its preventive measure.

For example, Patent Literature 1 describes a technique of preventing cracking at an end part in automatic welding by using a stepped sealing cascade bead in a plurality of layers from a terminal part of an end part of a weld joint toward a start end.

Patent Literature 2 discloses a multi-electrode submerged arc welding method capable of obtaining a good welded joint for a wide range of joint thickness by defining a groove shape of a butt portion, a current value of each electrode, and the like.

### CITATION LIST

### Patent Literature

Patent Literature 1: JP-A-H08-99177

Patent Literature 2: JP-A-2007-268551

### SUMMARY OF INVENTION

### Technical Problem

In the technique using the sealing cascade bead in Patent Literature 1, prevention of cracks is achieved by preventing deformation of the end part of the weld joint with the sealing cascade bead. However, since a penetration bead is not formed at the portion where the sealing cascade bead is formed, reworking is necessary after the welding. In addition, since it is necessary to form the sealing cascade bead in advance, there is a problem that the number of welding steps increases, and there is room for improvement.

Further, in the multi-electrode submerged arc welding method described in Patent Literature 2, the setting of the welding conditions depending on a specific welding speed is not considered, and a better welding quality is required.

The present invention has been made in view of the above problems, and an object thereof is to provide a one-side submerged arc welding method and a one-side submerged arc welding device, which can be applied to steel plates of a wide range of thickness, can prevent rotational deformation, can prevent cracks of the weld metal at the end part of the weld joint, and can avoid reworking after the welding.

### Solution to Problem

The above object of the present invention can be achieved by the following configuration.

The present invention is a one-side submerged arc welding method, including joining two steel plates butted against each other by submerged arc welding from one side using a plurality of electrodes,
in which during the submerged arc welding, at least one of electrode distances between adjacent electrodes in an end part region of the steel plates is reduced to be smaller than the at least one of electrode distances in a region in front of the end part region,
in which in reducing the at least one of electrode distances, an increasing section of change rate from when a change of the at least one of electrode distances starts to when the change rate of the at least one of electrode distances reaches its maximum has a time of 2 seconds or more.

In the method, in reducing the at least one of electrode distances, the increasing section of change rate from when a change of the at least one of electrode distances starts to when the change rate of the at least one of electrode distances reaches its maximum preferably has a length of 50 mm or more.

In the method, an average value of the change rate in the increasing section is preferably 180 mm/min or less.

In the method, in reducing the at least one of electrode distances, a decreasing section from when the change rate is maximum to when the change of the at least one of electrode distances ends preferably has a time of 2 seconds or more.

In the method, in reducing the at least one of electrode distances, a decreasing section from when the change rate is maximum to when the change of the at least one of electrode distances ends preferably has a length of 50 mm or more.

In the method, an average value of the change rate in the decreasing section is preferably 180 mm/min or less.

The present invention is a one-side submerged arc welding device for joining two steel plates butted against each other by submerged arc welding from one side, the one-side submerged arc welding device including:
a welding unit, including a plurality of electrodes and a plurality of power sources to supply power to the plurality of electrodes, and being movable in a predetermined direction to perform welding from a start end to an end part of each of the steel plates by the plurality of electrodes;
a drive mechanism disposed in the welding unit and capable of moving at least one of the plurality of electrodes in an advancing and retracting direction with respect to the welding unit; and
a control unit configured to control the drive mechanism to reduce, during the submerged arc welding, at least one of electrode distances between adjacent electrodes in an end part region of the steel plates to be smaller than the at least one of electrode distances in a region in front of the end part region,
in which in reducing the at least one of electrode distances, an increasing section of change rate from when a change of the at least one of electrode distances starts to when the change rate of the at least one of electrode distances reaches its maximum has a time of 2 seconds or more.

In the device, the increasing section of change rate from when a change of the at least one of electrode distances starts to when the change rate of the at least one of electrode distances reaches its maximum preferably has a length of 50 mm or more.

In the device, an average value of the change rate in the increasing section is preferably 180 mm/min or less.

In the device, in reducing the at least one of electrode distances, a decreasing section from when the change rate is maximum to when the change of the at least one of electrode distances ends preferably has a time of 2 seconds or more.

In the device, in reducing the at least one of electrode distances, a decreasing section from when the change rate is maximum to when the change of the at least one of electrode distances ends preferably has a length of 50 mm or more.

In the device, an average value of the change rate in the decreasing section is preferably 180 mm/min or less.

### Advantageous Effects of Invention

According to the one-side submerged arc welding method and one-side submerged arc welding device of the present invention, during the submerged arc welding, at least one of electrode distances between adjacent electrodes in the end part region of the steel plates is reduced to be smaller than the at least one of electrode distances in a region in front of the end part region. In addition, in reducing the at least one of electrode distances, an increasing section of change rate from when the change of the at least one of electrode distances starts to when the change rate of the at least one of electrode distances reaches its maximum has a time of 2 seconds or more. Thanks to this configuration, the penetration shape and strain rate in the end part region are controlled, and the surface shape of the bead in the transitional region is flattened. Accordingly, the techniques of the present invention can be applied to steel plates of a wide range of thickness, can prevent rotational deformation, can prevent cracks of the weld metal at the end part of the weld joint, and can avoid reworking after the welding.

### BRIEF DESCRIPTION OF DRAWINGS

FIG. 1 is a schematic diagram of a welding device to which the one-side submerged arc welding method of the present invention is applied.

FIG. 2 is a plan view of a steel plate welded by the one-side submerged arc welding method of the present invention.

FIG. 3 is a schematic explanatory diagram of the vicinity of a steel plate showing how the one-side submerged arc welding is performed.

FIG. 4 is a schematic explanatory diagram of the vicinity of a steel plate showing how the one-side submerged arc welding is performed.

FIG. 5A is a schematic diagram illustrating the state when the electrode distance is changed in the case of performing submerged arc welding with two electrodes.

FIG. 5B is a schematic diagram illustrating the state where the electrode distance is changed in the case of performing submerged arc welding with three electrodes.

FIG. 5C is a schematic diagram illustrating the state where the electrode distance is changed in the case of performing submerged arc welding with four electrodes.

FIG. 6 is a cross-sectional diagram of a welded joint showing a surface bead and a penetration bead.

FIG. 7A is a graph illustrating the relationship between the position of the welder in the transitional region D3 and the change rate of the electrode distance.

FIG. 7B is a graph illustrating the relationship between the position of the welder in the transitional region D3 and the electrode distance.

FIG. 8A is an example of the cross-sectional diagram illustrating the surface bead shape when the length of the increasing section is short.

FIG. 8B is an example of the cross-sectional diagram illustrating the surface bead shape in the case where the length of the increasing section specified in the present embodiment is long.

FIG. 9A is a graph corresponding to FIG. 7A, illustrating a modification example of the increase and decrease of the change rate in an increasing section and a decreasing section.

FIG. 9B is a graph corresponding to FIG. 7A, illustrating another modification example of the increase and decrease of the change rate in an increasing section and a decreasing section.

### DESCRIPTION OF EMBODIMENTS

### First Embodiment

Hereinafter, a one-side submerged arc welding method and a one-side submerged arc welding device in a first embodiment of the present invention are described in detail with reference to the drawings.

First, an outline of main portions of a one-side submerged arc welding device 10 (hereinafter, also referred to as welding device 10) is described.

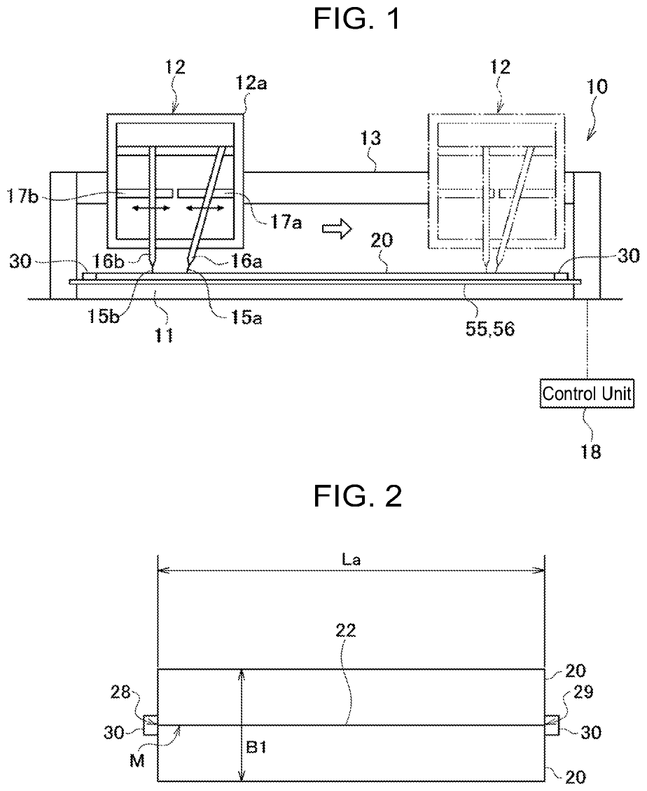

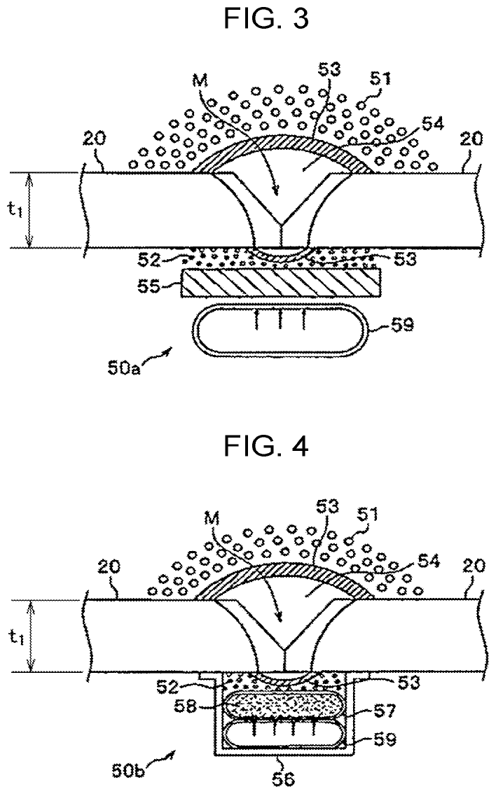

As shown in FIG. 1, the welding device 10 mainly includes a base frame 11, welders (welding units) 12, a welder beam 13, and a control unit 18. The base frame 11 is formed by a steel square bar and is formed in a concave shape in a cross-sectional view with an upper side opened, and includes a backing device 50a or a backing device 50b (see FIG. 3 and FIG. 4) supported therein. A steel plate 20 is placed on a backing copper plate 55 of the backing device 50a or a fireproof canvas 56 of the backing device 50b.

The welder beam 13 allows the welders 12 to move along a longitudinal direction of the steel plate 20.

Each of the welders 12 is disposed in a casing 12a along the longitudinal direction of the steel plate 20, and includes a first electrode 15a preceding during welding, and a second electrode 15b following the first electrode 15a. The electrodes 15a and 15b are disposed to be inserted into a first torch 16a and a second torch 16b, respectively. In addition, the torches 16a and 16b are connected via cables to a first power source (not shown) and a second power source (not shown), respectively, for supplying a current at a specified voltage. The first electrode 15a and the second electrode 15b are supplied with a current via the first torch 16a and the second torch 16b, respectively. The electrodes 15a and 15b are welding wires.

The welder 12 includes a first drive mechanism (slider) 17a which allows the first torch 16a to move along the longitudinal direction of the steel plate 20 with respect to the casing 12a and a second drive mechanism (slider) 17b which allows the second torch 16b to move along the longitudinal direction of the steel plate 20 with respect to the casing 12a. The first drive mechanism 17a and the second drive mechanism 17b are each disposed in the casing 12a. The first torch 16a and the second torch 16b are moved by the first drive mechanism 17a and the second drive mechanism 17b, so that the first electrode 15a and the second electrode 15b are moved.

The welder 12 is disposed above the base frame 11 (above the steel plate 20), moves at a specified speed along an extension direction (specified direction) of the welder beam 13 and welds the steel plate 20 by one-side submerged arc welding with the electrodes 15a and 15b from the front side of a groove M (see FIG. 3) of the steel plate 20.

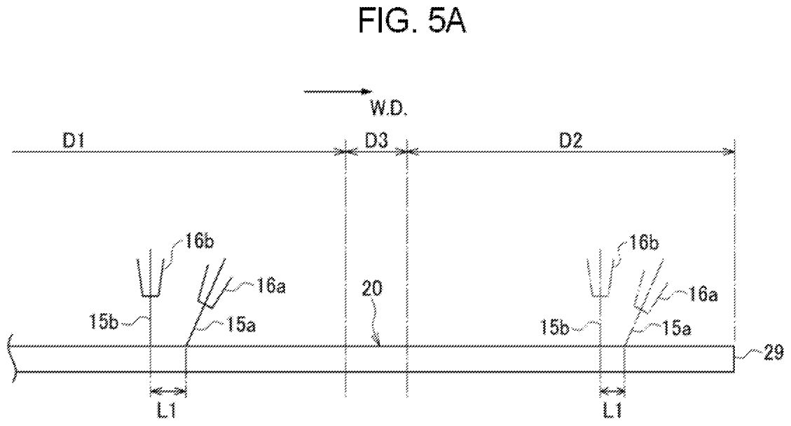

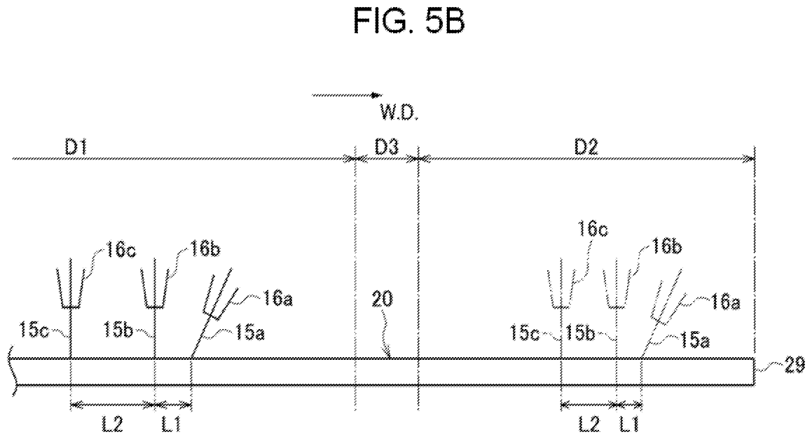

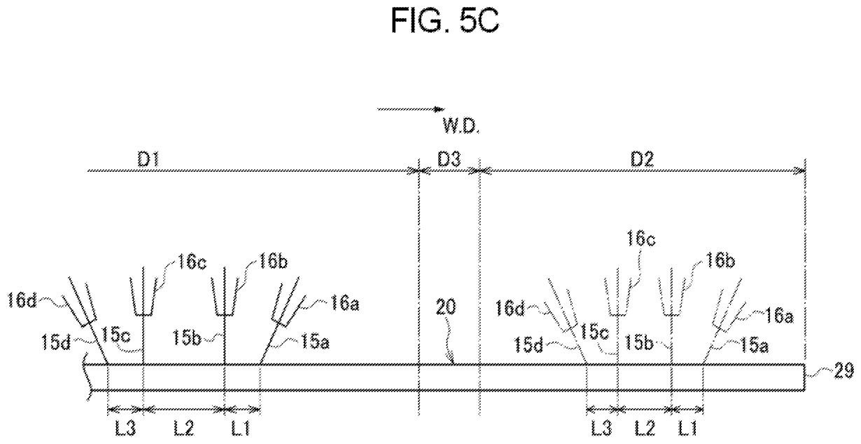

Further, the welder 12 drives and controls the first drive mechanism 17a and the second drive mechanism 17b by the control unit 18, so that the first electrode 15a and the second electrode 15b can be moved along the welder beam 13, and an electrode distance L1 between the first electrode 15a and the second electrode 15b can be changed (see FIG. 5A). The welder 12 may include only one of the drive mechanisms 17a and 17b. In addition, in the present embodiment, the electrode distance refers to a distance between electrodes at the surface height of steel plates to be welded.

In FIG. 1 and FIG. 5A, only two electrodes, i.e. the first electrode 15a and the second electrode 15b, are shown as electrodes (welding torch), but the number of electrodes is appropriately selected depending on the thickness of the steel plate 20 to be arc-welded, and it is optional to provide two or more electrodes. With regard to the number of the electrodes, one electrode is unsuitable for welding thick steel plates, and high efficiency of welding can be achieved with 5 or more electrodes, but there is room for further improvement for achieving both of the efficiency and the welding quality. When the number of the electrodes is 2 or more, it can be applied to welding of thick steel plates. On the other hand, when the number of the electrodes is 4 or less, the efficiency of welding can be enhanced, and the welding quality can be further improved. Accordingly, with two to four electrodes, it can be applied to thick steel plates, and it is easier to achieve both high efficiency and welding quality.

Therefore, the welder 12 may include, for example, first to third electrodes 15a, 15b and 15c as shown in FIG. 5B, or may include first to fourth electrodes 15a, 15b, 15c, and 15d as shown in FIG. 5C. In addition, in a welder including 3 or more electrodes, a power source and a drive mechanism can also be provided for each electrode.

As shown in FIG. 3 and FIG. 4, the one-side submerged arc welding method (hereinafter, also referred to as “the main welding”) is a method of performing welding by pressing a backing flux 52 spread in layers on the backing copper plate 55 or a backing flux 52 housed in the fireproof canvas 56 from back surfaces of the butted steel plates 20, 20 with a lifting mechanism such as an air hose 59. In the one-side submerged arc welding method, the submerged arc welding is performed from the front side of the steel plate 20 using a front flux 51 to simultaneously form beads on the front and back surfaces of the steel plate 20. In the drawings, reference numeral 53 denotes a slag, reference numeral 54 denotes a weld metal, reference numeral 57 denotes a flux bag, and reference numeral 58 denotes an underlying flux.

The steel plate 20 to which the one-side submerged arc welding method of the present embodiment is applied is, for example, a steel plate for shipbuilding. As shown in FIG. 2 and FIG. 3, a thickness t1 of the steel plate 20 is 5 mm or more and 40 mm or less, preferably 10 mm or more and 30 mm or less, and more preferably 18 mm or more and 25 mm or less. In addition, a total width B1 of the two steel plates 20 butted against each other is 300 mm or more. Further, a length La of the steel plate 20 is 1000 mm or more and 35000 mm or less.

The groove M is formed in a joint surface 22 in which the two steel plates 20 are butted against each other. The shape of the groove M may be any shape such as a Y groove or a V groove.

In addition, in the present embodiment, intermittent or continuous in-plane tacking is performed on the joint surface 22 of the steel plates 20. That is, in the present embodiment, no sealing cascade bead is formed.

Further, tab plates 30 are each attached to a start end 28 and an end part 29 of the steel plate 20. The tab plate 30 is used for the purpose of escaping a molten pool (crater) finally solidified from the welded joint in the one-side submerged arc welding, and for more effectively preventing cracks of the weld metal at the end part of the weld joint by the one-side submerged arc welding. Particularly, the tab plate 30 restrains the steel plate 20 at the end part of the weld joint, so that the thermal deformation due to the welding is prevented and the cracks at the end part of the weld joint are prevented.

Thereafter, the main welding (one-side submerged arc welding) of the steel plates 20 is performed from the start end 28 to the end part 29 of the steel plates 20. The main welding speed is, for example, 300 mm/min to 2,100 mm/min (30 cpm to 210 cpm). When the main welding speed is 300 mm/min to 2,100 mm/min, the welding quality can be ensured stably for the steel plate 20 having a thickness of 5 mm or more and 40 mm or less.

The “main welding” refers to welding to be performed on the steel plate 20 on which tack welding has been performed. In addition, “the main welding speed” refers to a speed of the submerged arc welding which is typically performed in the related art. Typically, the welding speed in the main welding is constant, but the speed may be slightly reduced depending on the welding position for the convenience of the welding process. However, the welding speed of the main welding is an optimum speed of the main welding conditions, that is, the preset main welding speed.

At this time, when the welding is performed under the same welding conditions (for example, specified number of electrodes, welding speed, total heat input, and electrode distance) from the start end 28 to the end part 29, cracks may occur at the end part of the weld joint. For example, under the condition of a high welding speed, rotational deformation may occur at the end part of the weld joint from the inner side to the outer side of the steel plate 20, and cracking at end part may occur. Specifically, the strain rate at which the steel plate 20 spreads from the inner side to the outer side increases, and the driving force in the direction of cracks of the steel plate 20 increases. In addition, depending on the welding conditions, there may be a case where a penetration shape with poor crack resistance is formed at the end part of the weld joint.

Here, in the present embodiment, as shown in FIG. 1 and FIG. 5A, during the submerged arc welding in which the strain rate is low and a penetration shape good for crack resistance can be obtained at the end part of the weld joint, the electrode distance L1 between the adjacent electrodes 15a and 15b is narrowed in an end part region D2 from a position at least 150 mm or more in front of the end part 29 of the steel plate 20 to the end part 29 and a region D1 (including the start end 28) in front of the end part region. That is, the change of the electrode distance can be performed by the control unit 18 through the control of at least one of the drive mechanisms 17a and 17b to allow the first and second electrodes 15a and 15b to move relative to each other during the movement of the casing 12a along the groove M.

That is, in the present embodiment, by changing the electrode distance in the end part region D2 to a specified value depending on the welding conditions such as the number of electrodes, the welding speed, and the heat input in the region D1 in front of the end part region, the strain rate is reduced, the penetration shape is changed by the first and second electrodes 15a and 15b, and the penetration shape with good crack resistance is ensured. Accordingly, in the end part of the weld joint, the crack prevention can be achieved, and a welded joint having a good surface bead appearance can be produced. Particularly in a case where the welding speed is high, cracking at end part is likely to occur, but in the welding method of the present embodiment, good penetration shape can be obtained, the strain rate can be reduced, and the prevention of cracking at end part can be achieved, even in the case where the welding speed is high. In the submerged arc welding method in the related art, there is no viewpoint of changing the electrode distance during the welding. On the other hand, the submerged arc welding method in the present embodiment has been completed as a result of intensive investigations by the inventors focusing on the penetration shape and the strain rate.

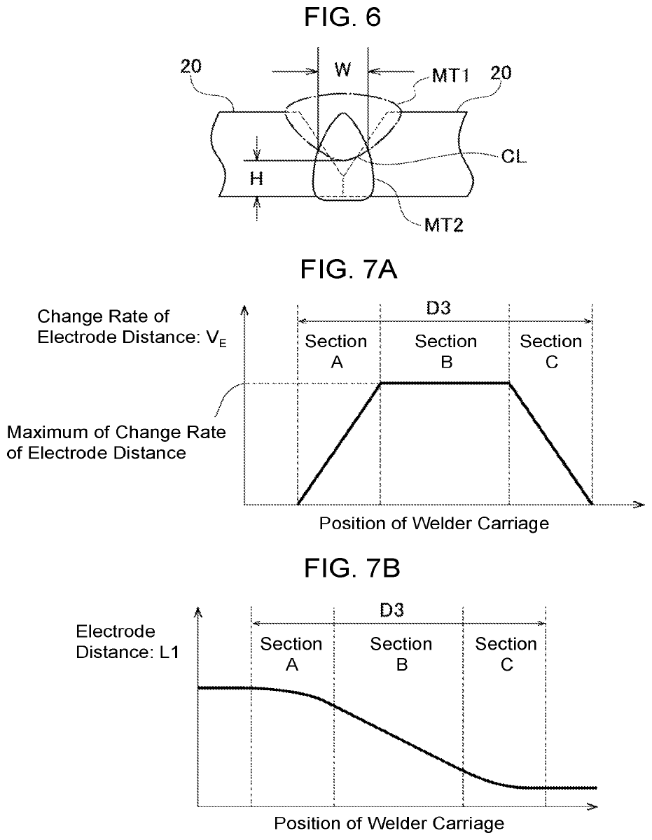

The evaluation of the penetration shape as an index indicating the strength of the material with respect to a crack is described. In a welded portion to be evaluated, cutting is performed in a plane perpendicular to the welding direction, and polishing and appropriate etching are performed to obtain a cross section as shown in FIG. 6. Here, when a distance from a cross plane CL of a weld metal MT1 constituting a surface bead formed by the second electrode 15b and a weld metal MT2 constituting a penetration bead formed by the first electrode 15a to the back surface of the steel plate 20 is H, and the width of the cross plane CL of the weld metal MT1 and the weld metal MT2 is W, in a case where the value of H/W is 0.1 or more and 0.8 or less, a good penetration shape for crack resistance is obtained. The case where the value of H/W is less than 0.1 is not preferred, since the stability of the penetration bead shape is reduced. On the other hand, in a case where the value of H/W is more than 0.8, since cracks are likely to occur, the penetration shape is defective. Further, when the value of H/W is 0.3 or more and 0.6 or less, a better penetration shape is obtained.

The penetration shape (H/W) is influenced by the change in the temperature of the molten pool when the second electrode 15b is used to perform the welding due to the time from the welding of the first electrode 15a to the arrival of the second electrode 15b (welding speed and electrode distance) and the heat input. When the temperature of the molten pool changes, the penetration depth of the second electrode 15b changes, and thus, the value of H/W changes.

As illustrated in FIG. 5B, in the case where the number of electrodes is 3, the weld metal MT1 constituting the surface bead is formed by the third electrode 15c, and the weld metal MT2 constituting the penetration bead is formed by the first and second electrodes 15a and 15b. In this case, it is preferable to change the electrode distance between the second electrode 15b and the third electrode 15c.

However, the weld metal MT1 constituting the surface bead may be formed by the second and third electrodes 15b and 15c, and the weld metal MT2 constituting the penetration bead may be formed by the first electrode 15a. In this case, it is preferable to change the electrode distance between the first electrode 15a and the second electrode 15b.

In addition, as illustrated in FIG. 5C, in the case where the number of electrodes is 4, the weld metal MT1 constituting the surface bead is formed by the third and fourth electrodes 15c and 15d, and the weld metal MT2 constituting the penetration bead is formed by the first and second electrodes 15a and 15b. Therefore, a cross plane CL of the weld metals MT1 and MT2 is provided in either case where the number of the electrodes is 3 or where it is 4. In this case, it is preferable to change the electrode distance between the second electrode 15b and the third electrode 15c.

However, the weld metal MT1 constituting the surface bead may be formed by the fourth electrode 15d, and the weld metal MT2 constituting the penetration bead may be formed by the first, second and third electrodes 15a, 15b and 15c. In this case, it is preferable to change the electrode distance between the third electrode 15c and the fourth electrode 15d.

Alternatively, the weld metal MT1 constituting the surface bead may be formed by the second, third and fourth electrodes 15b, 15c and 15d, and the weld metal MT2 constituting the penetration bead may be formed by the first electrode 15a In this case, it is preferable to change the electrode distance between the first electrode 15a and the second electrode 15b.

The change of the electrode distance L1 between the first and second electrodes 15a and 15b may be performed at position(s) from any position in front of the end part to the end part 29 of the steel plate 20. However, it is desirable to change the electrode distance L1 from a position where the amount of deformation is small depending on the length La of the steel plate 20. For example, the change of the electrode distance L1 is preferably performed at a position which is 150 mm or more in front of the end part 29 of the steel plate 20, more preferably performed at a position which is 300 mm or more in front of the end part 29 of the steel plate 20, still more preferably performed at a position which is 500 mm or more in front of the end part 29 of the steel plate 20, and particularly preferably performed at a position which is 1,000 mm or more in front of the end part 29 of the steel plate 20.

In addition, the change of the electrode distance L1 may be performed in a transitional region D3 between the region D1 which is in front of the end part region and the end part region D2.

That is, in the welding of the steel plate 20, when the first and second electrodes 15a and 15b come to the transitional region D3 which is slightly closer to the start end 28 than a position which is in front of the end part 29 of the steel plate 20 and is at least 150 mm away from the end part 29, control of at least one of the drive mechanisms 17a, 17b gradually starts, and when the first and second electrodes 15a and 15b come to the end part region D2, the change of the electrode distance L1 is completed. The length of the transitional region D3 is not particularly limited, but is, for example, 50 mm to 500 mm.

FIG. 7A is a graph illustrating the relationship between the position of the welder 12 in the transitional region D3 and the change rate V_{E} of the electrode distance L1, and FIG. 7B is a graph illustrating the relationship between the position of the welder 12 in the transitional region D3 and the electrode distance L1.

Specifically, in the transitional region D3, the electrode distance L1 is reduced by changing the change rate V_{E} of the electrode distance L1 as illustrated in FIG. 7A. That is, as for the change rate V_{E} of the electrode distance L1, the change rate V_{E} is increased in the section A from when the change of the electrode distance L1 starts to when the change rate V_{E} reaches its maximum, the change rate V_{E} is thereafter kept constant in the section B, and furthermore, the change rate V_{E} is decreased in the section C from when the change rate V_{E} is maximum to when the change of the electrode distance ends.

The change rate V_{E} of the electrode distance is a displacement per unit time of the electrode distance between electrodes.

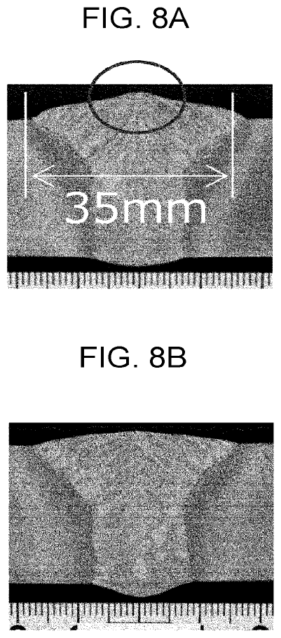

On this occasion, for example, in the case where the change rate V_{E} is varied by activating the drive mechanism 17b so as to move the second electrode 15b close to the first electrode 15a, if the increasing section A from when the change of the electrode distance L1 starts to when the change rate V_{E} reaches its maximum is short and has a time of less than 2 seconds, as illustrated in FIG. 8A, the surface shape of the surface bead becomes convex.

Therefore, in the present embodiment, the increasing section A is set to have a time of 2 seconds or more and thus the change rate V_{E} of the electrode distance L1 gently increases, such that the change in the welding speed per unit time is reduced. As a result, as illustrated in FIG. 8B, the surface shape of the surface bead formed in the increasing section A is flattened, and the rework man-hours can be reduced.

The increasing section A is preferably set to have a length of 50 mm or more so that the change rate V_{E} of the electrode distance L1 in the increasing section A can gently increase.

In addition, the average value of the change rate V_{E} in the increasing section A is preferably 180 mm/min or less so that the change rate V_{E} of the electrode distance L1 in the increasing section A can gently increase. Here, the average value of the change rate V_{E} in the increasing section A is a value obtained by dividing the displacement of the electrode distance from when the change of the electrode distance starts to when the change rate reaches its maximum, by the time required for the increasing section A.

As for the increase in the change rate V_{E} of the electrode distance L1, the drive mechanism 17a can also be activated to move the first electrode 15a close to the second electrode 15b, but in this case, if the increasing section from when the change of the electrode distance L1 starts to when the change rate V_{E} reaches its maximum is short, the surface shape of the penetration bead becomes convex.

However, even in this case, when the increasing section A is set to have a time of 2 seconds or more, the change rate V_{E} of the electrode distance L1 gently increases and therefore, the change in the welding speed per unit time is reduced. As a result, the surface shape of the penetration bead formed in the increasing section A is flattened, and the rework man-hours can be reduced.

Furthermore, in the case of activating the drive mechanism 17b to move the second electrode 15b close to the first electrode 15a, if the decreasing section C from when the change rate V_{E} is maximum to when the change of the electrode distance L1 ends is short and has a time of less than 2 seconds, as with the increasing section A, the surface shape of the surface bead becomes convex.

Accordingly, when the decreasing section C is set to have a time of 2 seconds or more, the change rate V_{E} of the electrode distance L1 gently decreases and therefore, the change in the welding speed per unit time is reduced. As a result, the surface shape of the penetration bead formed in the decreasing section C is flattened, and the rework man-hours can be reduced.

Here, as with the increasing section A, the decreasing section C is preferably set to have a length of 50 mm or more so that the change rate V_{E} of the electrode distance L1 in the decreasing section C gently decreases.

In addition, the average value of the change rates V_{E} in the decreasing section C is preferably 180 mm/min or less so that the change rate V_{E} of the electrode distance L1 in the decreasing section C gently decreases.

Furthermore, as with the increasing section A, in the case of activating the drive mechanism 17a to move the first electrode 15a close to the second electrode 15b, when the decreasing section C is set to have a time of 2 seconds or more, the change rate V_{E} of the electrode distance L1 gently decreases and therefore, the change in the welding speed per unit time is reduced. As a result, the surface shape of the penetration bead formed in the decreasing section C is flattened.

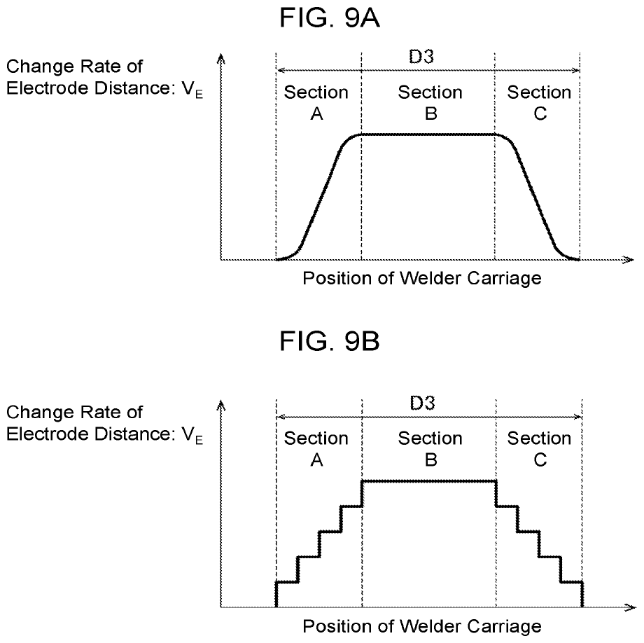

In addition, the manner of how the change rate V_{E} in the increasing section A or decreasing section C is increased or decreased is not limited to that illustrated in FIG. 7A. For example, as illustrated in FIG. 9A, it is also possible, in the increasing section A, to gradually increase the slope from the starting point of change of the electrode distance L1, then increase the change rate V_{E} at a constant slope, and gradually decrease the slope near a point where the change rate V_{E} reaches its maximum. Similarly, it is possible, in the decreasing section C, to gradually increase the slope from a point where the change rate V_{E} is maximum, then decrease the change rate V_{E} at a constant slope, and gradually decrease the slope near the end of change of the electrode distance L1.

Alternatively, as illustrated in FIG. 9B, in the increasing section A or decreasing section C, the change rate may be increased or decreased in a multistage manner.

As for the change of the electrode distance L1, in the case where the welder 12 has two electrodes, i.e., a first electrode and a second electrode, the electrode distance L1 between the first electrode and the second electrode is changed within a range of 250 mm or less.

In addition, in the case where the welder 12 has three electrodes, i.e., a first electrode, a second electrode and a third electrode, it is preferable to change the electrode distance L1 between the first electrode and the second electrode within a range of 250 mm or less and change the electrode distance L2 between the second electrode and the third electrode within a range of 250 mm or less.

Furthermore, in the case where the welder 12 has four electrodes, i.e., a first electrode, a second electrode, a third electrode and a fourth electrode, it is preferable to change the electrode distance L1 between the first electrode and the second electrode within a range of 250 mm or less, change the electrode distance L2 between the second electrode and the third electrode within a range of 250 mm or less, and change the electrode distance L3 between the third electrode and the fourth electrode within a range of 250 mm or less.

In all cases, it is more preferable to change each electrode distance within a range of 5 mm or more and 250 mm or less.

### Second Embodiment

Next, the one-side submerged arc welding method of a second embodiment is described. The welding device 10 used in the present embodiment is the same as that of the first embodiment.

In the one-side submerged arc welding method of the present embodiment, unlike the first embodiment in which the welding speed is constant from the start end 28 to the end part 29 of the steel plate 20, the welding is performed at a position which is 300 mm or more in front of the end part of the steel plate 20 to the end part 29 at a welding speed (hereinafter, referred to as a reduced welding speed appropriately) which is equal to or less than 75% of the welding speed of the main welding (hereinafter, referred to as the main welding speed appropriately).

At this time, when the total heat input in the main welding is Q (kJ/mm) and the total heat input in the welding at a welding speed of 75% or less is Q′ (kJ/mm), “Q′/Q=0.60 to 1.30” is satisfied.

When the reduced welding speed in the end part region D2 is equal to or less than 75% of the main welding speed, in the end part region D2, the strain rate can be reduced, and the driving force of the crack can be reduced, and in some cases, contraction deformation which leads to rotational deformation occurring from the inner side to the outer side of the steel plate 20 occurs. The reduced welding speed is preferably equal to or less than 60% of the main welding speed, and is more preferably equal to or less than 50% of the main welding speed. When the reduced welding speed is equal to or more than 40% of the main welding speed, the welding efficiency is not significantly impaired. In addition, when the reduced welding speed is equal to or more than 40% of the main welding speed, the current value for ensuring a good weld metal is high, it is not difficult to maintain the arc and the bead appearance is good.

In addition, in the welding of the steel plate 20, in a case where the welding speed is changed, the heat input is excessive and it is difficult to ensure the effect of prevention of the cracks and the welding quality, due to a low speed. That is, when the total heat input in the welding at a reduced welding speed is more than 1.30 times the total heat input at the main welding speed, the crack prevention effect is not recognized, and regarding the welding quality, the reinforcement of the penetration bead is excessive, making it impossible to obtain a good weld metal. On the other hand, when the total heat input in the welding at the reduced welding speed is less than 0.60 times the total heat input at the main welding speed, the crack prevention effect is recognized, but it is difficult to maintain the arc, and it is impossible to obtain a good weld metal for both the surface and penetration beads. Therefore, when the total heat input in the main welding is Q (kJ/mm) and the total heat input in the welding at a welding speed of 75% or less is Q′ (kJ/mm), “Q′/Q=0.60 to 1.30” is satisfied.

From the viewpoint of making it easier to obtain a good weld metal, the value of Q′/Q is preferably 0.70 or more, and more preferably 0.80 or more. In addition, from the viewpoint of the crack prevention effect in the end part region D2 and making it easier to obtain a good weld metal, the value of Q′/Q is preferably 1.20 or less.

The total heat input Q can be calculated by the following formula.

$$Q = {{\sum }^{n}}_{i = 1} \frac{{E}_{i} \times {I}_{i}}{{v}_{i}} \times 0 .06 \qquad [ Math . 1 ]$$

In the above formula, Q represents the total heat input (kJ/mm), Eᵢ represents the voltage (V), Iᵢ represents the current (A), vᵢ represents the welding speed (mm/min), i=1, 2, 3, . . . n, and i represents each electrode. The same applies to Q′ for the above formula. In addition, the total heat input here means the total of the heat inputs into the electrodes 15a, 15b . . . . In addition, the total heat input may be a value calculated by the above formula, or may be an actual measurement value (measurement value).

In the present embodiment, from the viewpoint of the amount of deformation at the end part of the weld joint, it is preferable that the change range of the welding speed is the end part region D2 from a position which is 300 mm or more in front of the end part of the steel plate 20 to the end part 29. In addition, the transitional region D3 in which the welding speed is changed from the main welding speed to the reduced welding speed may be appropriately set in the range of 50 mm to 500 mm.

Further, the change of the electrode distance and the change of the welding speed may be performed simultaneously or separately within the above range. Therefore, the change of the electrode distance may be performed from any position in front of the end part of the steel plate 20 to the end part 29.

Accordingly, when the welding speed (moving speed of the casing 12a) is reduced, the strain rate of the steel plate 20 is reduced, so that the driving force of the cracks can be reduced, but a penetration shape with poor crack resistance may be obtained. In contrast, as in the present embodiment, when the electrode distance is changed, the strain rate of the steel plate 20 is reduced, the penetration shape (H/W) with good crack resistance can be ensured, and crack prevention can be achieved.

For example, when the heat input is constant and the welding speed is reduced, since the temperature of the molten pool at the time of welding of the electrode to form the weld metal MT1 (see FIG. 8) is low, penetration of the electrode is shallow, H/W is large, and crack resistance is degraded. When the electrode distance is shortened at this time, since the temperature of the molten pool at the time of welding of the electrode to form the weld metal MT1 is high, the penetration of the electrode is deep, and H/W can be maintained in a range with good crack resistance.

Particularly, from the viewpoint of welding efficiency, the reduction in the welding speed is preferably as small as possible, and when the change of the electrode distance and the change of the welding speed are performed, for example, the crack prevention can be achieved while making the reduced welding speed higher than 70% of the main welding speed.

Other configurations and effects are similar to those of the first embodiment.

The present invention is not limited to the embodiments described above and Examples, and appropriate modifications, improvements, etc. can be made.

In each embodiment described above, a tab plate 30 is attached to the start end 28 and end part 29 of the steel plate 20, but in the present invention, the submerged arc welding method may be performed without using the tab plate 30. In addition, in the case of using the tab plate, the following configuration may also be employed. That is, denoting t1 as the thickness of the steel plate and t2 as the thickness of the tab plate, the relationship between the thickness of the steel plate and the thickness of the tab plate satisfies t2≥t1; the width B1 of two steel plates satisfies B1≥300 mm; and the width B2 of two tab plates satisfies B2≥10×t1 and 100 mm≤B2≤2000 mm. In addition, a groove of the steel plate and a groove of the tab plate, which are formed by butting two steel plates and two tab plates, respectively, have the same groove shape, and tack welding of the groove of the steel plate and the groove of the tab plate is performed from at least an end part of the steel plate to one end portion of the tab plate.

### EXAMPLES

Examples in the present invention are described below. In this Example, in the submerged arc welding, a predetermined electrode is moved to reduce a predetermined electrode distance in an end part region, and the increasing section (section A) from when the change of the electrode distance of the moving electrode starts to when the change rate reaches its maximum is configured to make a predetermined variation in the predetermined time and distance. The number of electrodes in the submerged arc welding, the main welding conditions, the time and distance of the increasing section, the average value of the change rates of the electrode distance, the form of increase of the change rate, and the method for changing the electrode distance (the electrode moved) are shown in Table 1. Furthermore, as test results, the evaluation results of surface bead shape and penetration bead shape of a specimen and the evaluation results of hot cracking are shown in Table 1.

Here, two steel plates used in the test were a rolled steel material SM400B for welded structures, having a size of 20 mm in thickness, 750 mm in width, and 1,200 mm in length, the wire was a solid wire of JIS Z 3351 YS-S6, and the flux was a bonded flux of JIS Z 3352 SACI1.

As for the surface bead shape and the penetration bead shape, the bead shapes on the front and back surfaces were observed in the increasing section and are recorded in Table 1 as good in the case where the surface shape of the bead is flattened to the same level as that before transition and recorded as defective in the case where the surface shape of the bead became convex in the increasing section.

As for hot cracking, after the completion of welding, the presence or absence of internal cracks was confirmed by an X-ray transmission test (JIS Z3104) within the range of 400 mm in front of the end part of the steel plate, and the presence or absence of cracks is recorded in Table 1.

Furthermore, in the case where the number of electrodes is 2, the weld metal constituting the surface bead is formed by the second electrode, and the weld metal constituting the penetration bead is formed by the first electrode. In the case where the number of electrodes is 3, the weld metal constituting the surface bead is formed by the third electrode, and the weld metal constituting the penetration bead is formed by the first electrode and the second electrode. In the case where the number of electrodes is 4, the weld metal constituting the surface bead is formed by the third electrode and the fourth electrode, and the weld metal constituting the penetration bead is formed by the first electrode and the second electrode.

In addition, except of specimen No. 23, the current and voltage values of each electrode and the welding speed after changing the electrode distance are the same as those before the change. On the other hand, in specimen No. 23, the current and voltage values of each electrode and the welding speed after changing the electrode distance are as follows.

### [Welding Conditions in No. 23 After Change of Electrode Distance]

First electrode: current 1,200 A, voltage 34 V
Second electrode: current 1,000 A, voltage 37 V
Third electrode: current 800 A, voltage 36 V
Fourth electrode: current 900 A, voltage 36 V
Welding speed: 720 mm/min

TABLE 1

| | | Main welding Conditions | | | | | | | |
|---|---|---|---|---|---|---|---|---|---|
| | | Current [A] | | | | Voltage [V] | | | |
| | Number of | First | Second | Third | Fourth | First | Second | Third | Fourth |
| No. | Electrodes | Electrode | Electrode | Electrode | Electrode | Electrode | Electrode | Electrode | Electrode |
| 1 | 2 | 900 | 800 | — | — | 35 | 35 | — | — |
| 2 | | 1000 | 800 | — | — | 35 | 35 | — | — |
| 3 | | 1100 | 1000 | — | — | 35 | 35 | — | — |
| 4 | 3 | 1200 | 800 | 800 | — | 34 | 42 | 44 | — |
| 5 | | 1300 | 900 | 900 | — | 34 | 42 | 44 | — |
| 6 | | 1400 | 1000 | 900 | — | 34 | 42 | 44 | — |
| 7 | | 1400 | 1000 | 1100 | — | 34 | 42 | 44 | — |
| 8 | 4 | 1400 | 1100 | 700 | 700 | 35 | 40 | 46 | 46 |
| 9 | | 1400 | 1100 | 700 | 700 | 35 | 40 | 46 | 46 |
| 10 | | 1400 | 1100 | 700 | 700 | 35 | 40 | 46 | 46 |
| 11 | | 1600 | 1500 | 1100 | 1200 | 35 | 40 | 46 | 46 |
| 12 | | 1700 | 1200 | 1000 | 1000 | 35 | 40 | 46 | 46 |
| 13 | | 1500 | 1200 | 1000 | 1000 | 35 | 40 | 46 | 46 |
| 14 | | 1500 | 1500 | 1200 | 1200 | 35 | 40 | 46 | 46 |
| 15 | | 1500 | 1300 | 1000 | 1000 | 35 | 40 | 46 | 46 |
| 16 | | 1600 | 1400 | 1000 | 1100 | 35 | 40 | 46 | 46 |
| 17 | | 1600 | 1400 | 1000 | 1100 | 35 | 40 | 46 | 46 |
| 18 | | 1600 | 1400 | 1000 | 1100 | 35 | 40 | 46 | 46 |
| 19 | | 1600 | 1400 | 1000 | 1100 | 35 | 40 | 46 | 46 |
| 20 | | 1400 | 1100 | 700 | 700 | 35 | 40 | 46 | 46 |
| 21 | | 1400 | 1100 | 700 | 700 | 35 | 40 | 46 | 46 |
| 22 | | 1400 | 1100 | 700 | 700 | 35 | 40 | 46 | 46 |
| 23 | | 1500 | 1300 | 1000 | 1000 | 35 | 40 | 46 | 46 |
| 24 | 4 | 1500 | 1200 | 1000 | 1000 | 35 | 40 | 46 | 46 |
| 25 | | 1500 | 1200 | 1000 | 1000 | 35 | 40 | 46 | 46 |
| 26 | | 1500 | 1200 | 1000 | 1000 | 35 | 40 | 46 | 46 |
| 27 | | 1500 | 1200 | 1000 | 1000 | 35 | 40 | 46 | 46 |
| 28 | | 1600 | 1400 | 1000 | 1100 | 35 | 40 | 46 | 46 |
| 29 | | 1500 | 1300 | 1000 | 1000 | 35 | 40 | 46 | 46 |
| | | | | Average | | | | | |
| | | | | Value of | | | | | |
| | | | | Change Rates | | | | | |
| | | Time | Length | V_{E} of | | | | | |
| | | of | of | Electrode | | | | | |
| | Welding | Section | Section | Distance in | Form of Increase- | | Surface | Penetration | |
| | speed | A | A | Section A | Decrease of | Method for Changing | Bead | Bead | Hot |
| No. | [mm/min] | [s] | [mm] | [mm/min] | Change Rate | Electrode Distance | Shape | Shape | Cracking |
| 1 | 420 | 9 | 63 | 180 | constant acceleration | move second electrode | good | good | none |
| | | | | | | to first electrode side | | | |
| 2 | 360 | 10 | 60 | 120 | constant acceleration | move second electrode | good | good | none |
| | | | | | | to first electrode side | | | |
| 3 | 300 | 16 | 80 | 150 | constant acceleration | move second electrode | good | good | none |
| | | | | | | to first electrode side | | | |
| 4 | 1020 | 3 | 51 | 120 | constant acceleration | move third electrode | good | good | none |
| | | | | | | to second electrode side | | | |
| 5 | 900 | 6 | 90 | 150 | constant acceleration | move third electrode | good | good | none |
| | | | | | | to second electrode side | | | |
| 6 | 720 | 6 | 72 | 150 | constant acceleration | move third electrode | good | good | none |
| | | | | | | to second electrode side | | | |
| 7 | 600 | 8 | 80 | 180 | constant acceleration | move third electrode | good | good | none |
| | | | | | | to second electrode side | | | |
| 8 | 1500 | 2 | 50 | 90 | constant acceleration | move third electrode | good | good | none |
| | | | | | | to second electrode side | | | |
| 9 | 1500 | 2 | 50 | 150 | constant acceleration | move third electrode | good | good | none |
| | | | | | | to second electrode side | | | |
| 10 | 1500 | 2 | 50 | 180 | constant acceleration | move third electrode | good | good | none |
| | | | | | | to second electrode side | | | |
| 11 | 1800 | 2 | 60 | 150 | constant acceleration | move third electrode | good | good | none |
| | | | | | | to second electrode side | | | |
| 12 | 2100 | 2 | 70 | 120 | constant acceleration | move third electrode | good | good | none |
| | | | | | | to second electrode side | | | |
| 13 | 1320 | 4 | 88 | 120 | constant acceleration | move third electrode | good | good | none |
| | | | | | | to second electrode side | | | |
| 14 | 600 | 5 | 50 | 150 | constant acceleration | move third electrode | good | good | none |
| | | | | | | to second electrode side | | | |
| 15 | 1080 | 5 | 90 | 150 | constant acceleration | move third electrode | good | good | none |
| | | | | | | to second electrode side | | | |
| 16 | 720 | 7 | 84 | 90 | constant acceleration | move third electrode | good | good | none |
| | | | | | | to second electrode side | | | |
| 17 | 720 | 7 | 84 | 120 | constant acceleration | move third electrode | good | good | none |
| | | | | | | to second electrode side | | | |
| 18 | 720 | 7 | 84 | 150 | constant acceleration | move third electrode | good | good | none |
| | | | | | | to second electrode side | | | |
| 19 | 720 | 10 | 120 | 180 | constant acceleration | move third electrode | good | good | none |
| | | | | | | to second electrode side | | | |
| 20 | 1500 | 2 | 50 | 180 | gradually accelerated | move third electrode | good | good | none |
| | | | | | (FIG. 9A) | to second electrode side | | | |
| 21 | 1500 | 2 | 50 | 180 | multistage acceleration | move third electrode | good | good | none |
| | | | | | (FIG. 9B) | to second electrode side | | | |
| 22 | 1500 | 2 | 50 | 180 | constant acceleration | move second electrode | good | good | none |
| | | | | | | to third electrode side | | | |
| 23 | 1080 | 2 | 36 | 180 | constant acceleration | move second electrode | good | good | none |
| | | | | | | to third electrode side | | | |
| 24 | 1320 | 1 | 22 | 300 | constant acceleration | move third electrode | convex bead | good | none |
| | | | | | | to second electrode side | occurred | | |
| 25 | 1320 | 0.5 | 11 | 210 | constant acceleration | move third electrode | convex bead | good | none |
| | | | | | | to second electrode side | occurred | | |
| 26 | 1320 | 0.5 | 11 | 240 | constant acceleration | move third electrode | convex bead | good | none |
| | | | | | | to second electrode side | occurred | | |
| 27 | 1320 | 1 | 22 | 240 | constant acceleration | move second electrode | good | convex bead | none |
| | | | | | | to third electrode side | | occurred | |
| 28 | 720 | 1.5 | 18 | 240 | constant acceleration | move third electrode | convex bead | good | none |
| | | | | | | to second electrode side | occurred | | |
| 29 | 1080 | 0 | 0 | 0 | no acceleration | no change of | good | good | present |
| | | | | | | electrode distance | | | |

In Table 1, No. 1 to No. 23 are Examples of the invention and No. 24 to No. 29 are Comparative Examples. More specifically, in No. 29, the submerged arc welding was performed under the same welding conditions from the start end to the end part, and hot cracking was observed in the end part of the weld joint. In No. 24 to No. 28, the electrode was moved so as to reduce the electrode distance in the end part of the weld joint and in turn, hot cracking in the end part of the weld joint was prevented. However, in No. 24 to No. 28, the time of the increasing section in the transitional region was less than 2 seconds and therefore, either the surface bead shape or the penetration bead shape became convex.

On the other hand, in No. 1 to No. 23 where the electrode was moved so as to reduce the electrode distance in the end part of the weld joint and the time of the increasing section in the transitional region was 2 seconds or more, hot cracking was prevented, and both the surface bead shape and the penetration bead shape were good, demonstrating the effects of the present invention.

The present invention is based on Japanese patent application No. 2018-015837 filed on Jan. 31, 2018, the contents of which are incorporated herein by reference.

### REFERENCE SIGNS LIST

10 One-side submerged arc welding device
11 Base frame
12 Welder (welding unit)
12a Casing
13 Welder beam
15a First electrode
15b Second electrode
15c Third electrode
15d Fourth electrode
16a First torch
16b Second torch
17a First drive mechanism (slider)
17b Second drive mechanism (slider)
18 Control unit
20 Steel plate
22 Joint surface
28 Start end
29 End part
30 Tab plate

1. A one-side submerged arc welding method, comprising joining two steel plates butted against each other by submerged arc welding from one side using a plurality of electrodes,
wherein during the submerged arc welding, at least one of electrode distances between adjacent electrodes in an end part region of the steel plates is reduced to be smaller than the at least one of electrode distances in a region in front of the end part region,
wherein in reducing the at least one of electrode distances, an increasing section of change rate from when a change of the at least one of electrode distances starts to when the change rate of the at least one of electrode distances reaches its maximum has a time of 2 seconds or more.

2. The one-side submerged arc welding method according to claim 1, wherein the increasing section has a length of 50 mm or more.

3. The one-side submerged arc welding method according to claim 1, wherein an average value of the change rate in the increasing section is 180 mm/min or less.

4. The one-side submerged arc welding method according to claim 1, wherein in reducing the at least one of electrode distances, a decreasing section from when the change rate is maximum to when the change of the at least one of electrode distances ends has a time of 2 seconds or more.

5. The one-side submerged arc welding method according to claim 4, wherein the decreasing section has a length of 50 mm or more.

6. The one-side submerged arc welding method according to claim 4, wherein an average value of the change rate in the decreasing section is 180 mm/min or less.

7. A one-side submerged arc welding device for joining two steel plates butted against each other by submerged arc welding from one side, the one-side submerged arc welding device comprising:
a welding unit, including a plurality of electrodes and a plurality of power sources to supply power to the plurality of electrodes, and being movable in a predetermined direction to perform welding from a start end to an end part of each of the steel plates by the plurality of electrodes;
a drive mechanism disposed in the welding unit and capable of moving at least one of the plurality of electrodes in an advancing and retracting direction with respect to the welding unit; and
a control unit configured to control the drive mechanism to reduce, during the submerged arc welding, at least one of electrode distances between adjacent electrodes in an end part region of the steel plates to be smaller than the at least one of electrode distances in a region in front of the end part region,
wherein in reducing the at least one of electrode distances, an increasing section of change rate from when a change of the at least one of electrode distances starts to when the change rate of the at least one of electrode distances reaches its maximum has a time of 2 seconds or more.

8. The one-side submerged arc welding device according to claim 7, wherein the increasing section has a length of 50 mm or more.

9. The one-side submerged arc welding device according to claim 7, wherein an average value of the change rate in the increasing section is 180 mm/min or less.

10. The one-side submerged arc welding device according to claim 7, wherein in reducing the at least one of electrode distances, a decreasing section from when the change rate is maximum to when the change of the at least one of electrode distances ends has a time of 2 seconds or more.

11. The one-side submerged arc welding device according to claim 10, wherein the decreasing section has a length of 50 mm or more.

12. The one-side submerged arc welding device according to claim 10, wherein an average value of the change rate in the decreasing section is 180 mm/min or less.

13. The one-side submerged arc welding method according to claim 2, wherein an average value of the change rate in the increasing section is 180 mm/min or less.

14. The one-side submerged arc welding method according to claim 5, wherein an average value of the change rate in the decreasing section is 180 mm/min or less.

15. The one-side submerged arc welding device according to claim 8, wherein an average value of the change rate in the increasing section is 180 mm/min or less.

16. The one-side submerged arc welding device according to claim 11, wherein an average value of the change rate in the decreasing section is 180 mm/min or less.
